(19) United States
(12) Patent Application Publication
(10) Pub. No.: US 2004/0124587 A1
(43) Pub. Date: Jul. 1, 2004

(54) Sliding contact seal structure in shaft portion

(76) Inventor: Hiroshi Yamamoto, Kanagawa-ken (JP)

Correspondence Address: Michael S. Leonard, Bell, Boyd & Lloyd LLC, P.O. Box 1135, Chicago, IL, 60690-1135, US

(21) Appl. No.: 10/735,105

(22) Filed: Dec. 11, 2003

(30) Foreign Application Priority Data
Dec. 11, 2002 (JP) 2002-359083

(51) Int. Cl. F16J 15/32

(52) U.S. Cl. 277/549

(57) ABSTRACT

A shaft member that comes into contact with a seal member and relatively swings with respect to the seal member is employed in a sliding contact seal structure of various machines. When the material of the seal member is combined with the material of the shaft member such that the sum of the surface energies thereof is 95 dyne/cm on the sliding contact surface thereof, the wear and damage of the seal member and the shaft member can be reduced, sealing performance can be improved, and necessary durability can be secured. Accordingly, there can be provided the sliding contact seal structure which does not wear and damage the shaft member and the seal members, is excellent in the sealing performance for a long period of time, and has sufficient durability without sticking to the surface hardness of the shaft member.

### BACKGROUND OF THE INVENTION

1. Field of the Invention

The present invention relates to a sliding contact structure of a sliding contact seal portion having an oil seal, a dust seal, and the like, and more particularly, to a sliding contact seal structure capable of suppressing the wear and damage of a seal member.

2. Description of the Related Art

Heretofore known as this type of the sliding contact seal structure is a sliding contact seal structure composed of seal member such as an oil seal, a dust seal, and the like attached to the opening of a cylindrical housing that is mounted outside of a bearing member for supporting, for example, a rotating shaft. In the sliding contact seal structure, the seal member comes into intimate contact with the rotating shaft to rotate, the housing swings through the rotating shaft, or the seal member attached to the housing comes into intimate contact with the periphery of a rod reciprocating within a cylinder and reciprocates. This sliding contact structure is applied to a rotating shaft, a swinging shaft, and a reciprocating shaft used in rolling stocks, construction and civil engineering machinery, and general machinery using hydraulic equipment, and the like.

This type of the sliding contact structure has a problem in that the contact pressure between the shaft member and the seal member is lost because the seal member in particular is worn or damaged by the sliding contact executed between the shaft member and the seal member, and thus the bearing member, the inside of the cylinder, and the shaft member are worn and damaged by the polishing action of dusts, water, earth and sand, and the like that invade from the outside.

An example of a sliding contact structure for preventing the wear of the shaft member and the seal member is disclosed in, for example, Japanese Unexamined Patent Application Publication No. 7-77281. The sealed structure of a gear device used in rolling stocks disclosed in the publication is arranged such that the gear device, in which a gear shaft is supported by a housing on one end side thereof through a pair of conical roller bearings and a gear is fixed to an end of the gear shaft, includes seal members each composed of a rubber oil seal for sealing between the housing and the gear shaft, and a slinger formed of a polyamide synthetic resin for shielding the oil seal from the outside.

In this sealed structure, the slinger and the oil seal are mounted in the housing and caused to come into sliding contact with the surface of the gear shaft, thereby the inside of the gear device is sealed double. Further, according to this sealed structure, a lubricant such as grease or the like is filled between the slinger and the oil seal, and as the gear shaft rotates, the lubricant is introduced onto the sliding contact surface between the oil seal and the gear shaft, and forms a thin lubricant film.

The sliding contact portion of the gear shaft, with which a lip portion of the oil seal comes into intimate and sliding contact, is subjected to a surface hardening treatment by being coated with ceramics such as Si₃N₄, or the like, formed with a TiN film, a TiAl₂N film, or a TiC film by a PVD method, or formed with a Fe₃N layer or a Fe₂N layer by an ion nitriding treatment.

In the ceramic coating, the sliding contact portion of the gear shaft can be hardened to a Vickers hardness of at least HV 1,500. In the PVD method, the sliding contact portion can be hardened to a Vickers hardness of at least HV 1,200. Further, in the ion nitriding treatment, the sliding contact portion can be hardened to a Vickers hardness of at least HV 2,000. Further, it is also possible to fit a ring-shaped steel member, which is subjected to the surface hardening treatment as described above, on the outer periphery of the gear shaft so that the ring-shaped steel member acts as a sliding contact portion to the slinger and the oil seal.

According to the sealed structure of the gear device used heretofore, since the surface of the sliding contact portion of the gear shaft is hardened to a Vickers hardness of at least HV 1,000, even if the lubricant is consumed or the sliding contact portion of the gear shaft is insufficiently lubricated, the sliding contact portion can be prevented from being worn by foreign particles and can exhibit a sealing performance for a long period of time. Further, in the structure in which the ring-shaped member is fitted on the sliding contact portion of the gear shaft, since the ring-shaped member can be independently subjected to the surface hardening treatment as described above, a gear shaft having a Vickers hardness of at least HV 1,000 can be easily obtained.

Further, according to Japanese Unexamined Patent Application Publication No. 2001-289330, a shaft member is composed of a steel as well as the steel is covered with a hard film for making the surface hardness of the steel to a Vickers hardness of HV 1,500 to HV 10,000 in order to eliminate the defect in the sealed structure of the gear device disclosed in Japanese Unexamined Patent Application Publication No. 7-77281. This arrangement is made to maintain the sealing function of a seal member for a long period of time without shifting the seal member to the surface of the shaft member and without producing worn powder by forming the hard film having the Vickers hardness of HV of 1,500 to HV 10,000 of a particular film forming material.

Incidentally, to secure the sealing function in this type of the seal structure, it is not sufficient only to increase the surface hardness of a shaft member as described above, and it is essential for a lip portion and a slinger to press the shaft member with a large amount of press force that is uniform in a peripheral direction in order to securely prevent the leakage of the lubricant from the inside or the outside of the seal structure and the invasion of dusts and muddy water from the outside thereof. However, when the press force applied by a seal member is increased in the sealed portion of the shaft member whose surface hardness is increased as described above, the seal member is more worn on the contrary, by which sealing performance may be deteriorated.

### SUMMARY OF THE INVENTION

Accordingly, an object of the present invention is to provide a sliding contact seal structure which is excellent in sealing performance and durability and in which a shaft member and a seal member are neither worn nor damaged for a long period of time without sticking to the surface hardness of the shaft member.

It is ordinarily contemplated that an increase in hardness of a shaft member which comes into contact with and slides on a seal member, can decrease the wear of the surface of the sliding shaft member and extend the life of a sealed portion, and this is reasonable as long as it is considered unilaterally. In this case, however, the wear of the seal member is not taken into consideration at all. Under the above circumstances, the inventors have variously examined a method of securing sealing property, waterproof property, dust proof property, oil leakage preventing property, and the like in the seal structure as described above without depending on only the hardness of the shaft member.

As a result, the inventors have found that surface energy peculiar to materials relates to wear property. Moreover, the inventors have found that when a certain relationship is satisfied between the surface energies of the shaft member and the seal member on the sliding contact surfaces thereof particularly in a sliding contact seal structure having the seal member which relatively slides on the shaft member in intimate contact therewith, the wear resistance and the durability of the seal member are improved even if the seal member press around the shaft member with a large amount of uniform press force and slides thereon.

The present invention has been achieved based on the above knowledge. That is, a first aspect of the present invention is characterized in that the surface energy of the shaft member is 50 dyne/cm or less on the sliding contact surface thereof. Usually, a seal member used in this type of the seal portion is composed of an urethane rubber, a polyethylene rubber, a PTFE rubber, a silicon rubber, and the like. Of these rubbers, the urethane rubber has a surface energy of 48 dyne/cm, the polyethylene rubber has a surface energy of 44 dyne/cm, and the PTFE rubber has a surface energy of 22 dyne/cm. In contrast, a steel has a surface energy of 50 dyne/cm as described above, and TiCN, for example, has a surface energy of 45 dyne/cm, and CrN has a surface energy of 33 dyne/cm. Further, a hydrogen free amorphous carbon film having a surface energy of 41 dyne/cm, a hydrogen containing amorphous carbon film having a surface energy of 47 dyne/cm, and the like are exemplified as materials whose surface energies are smaller than that of the steel.

A second aspect of the present invention is characterized in a sliding contact seal structure used in various machines having a shaft member that comes into contact with seal members and relatively slides with respect to the seal members, wherein the sliding contact seal structure is composed of a combination of the seal members and the shaft member, and the sum of the respective surface energies of which is 95 dyne/cm or less on the sliding contact surface thereof. The seal structure according to this invention can be effectively applied to a sliding contact portion between a rotating shaft, a reciprocating shaft, or a swinging shaft of rolling stocks, wind power generators, construction and civil engineering machinery, and the like and seal members such as oil seals, dust seals, mechanical seals, and the like.

According to the above arrangement, it is not always necessary to increase the surface hardness of the shaft member as disclosed in the above-mentioned publication, and it is sufficient to examine and determine the surface hardness from a view point of the relative surface energies of the shaft member and the seal member. That is, even if a steel (surface energy: 50 dyne/cm), which is heretofore used, is used as the shaft member, when a fluorine rubber (PTFE having a surface energy of 22 dyne/cm), for example, is used as a seal member, the surface of the shaft member is not worn because the seal member has wear resistance and the hardness of the surface of the shaft member is improved, thereby the durability of both the shaft member and the seal member can be improved.

From what has been described above, there is assumed a case that an ordinary steel, which is used in a usual sliding contact seal structure, and a seal member, which is composed of an urethane rubber, are employed, and the amount of wear of the seal member in this case is used as a reference. Under such circumstances, when a material having a surface energy lower than the surface energy of the seal member is used as a shaft member, a degree of freedom for selecting a material of a seal member whose surface energy is higher than the surface energy of the shaft member is increased, thereby the durability of the shaft member and the durability of the seal member can be simultaneously improved. Specifically, when the urethane rubber is used as the seal member, TiCN, CrN, and the like whose surface energy is smaller than 45 dyne/cm are preferably formed on the surface of the shaft member. Note that although these materials may be used as the mother material of the shaft member and the seal member themselves, the present invention includes a case that the materials described above are exposed on the sliding contact surface of the mother material by forming a film composed of these materials or coating these materials on the sliding contact surfaces of both the shaft member and the seal member.

### BRIEF DESCRIPTION OF THE DRAWINGS

FIG. 1 is a sectional view showing a schematic structure of a wind power generator having an oil seal portion as an example of a sliding contact seal structure of an embodiment of the present invention;

FIG. 2 is a sectional view schematically showing the main portion of an example of a nacell turning mechanism of the wind power generator;

FIG. 3 is a sectional view showing an example of a nacell turning drive unit;

FIG. 4 is a partly enlarged sectional view of a sliding contact seal portion in the nacell turning drive unit;

FIG. 5 is a graph explaining the relationship between the amounts of wear of various seal members used in the sliding contact seal portion and the surface energies of shaft members;

FIG. 6 is a sectional view showing an example of a sliding contact seal structure of another embodiment of the present invention; and

FIG. 7 is a graph explaining the relationship between the materials of the shaft portion of the sliding contact seal structure and the amount of wear of an urethane rubber as a seal member.

### DESCRIPTION OF THE PREFERRED EMBODIMENTS

Preferable embodiments of the present invention will be specifically explained below with reference to the accompanying drawings.

The present invention can be effectively applied to a sliding contact seal structure, in which a rotating shaft, a reciprocating shaft, or a swinging shaft is used in, for example, not shown rolling stocks, construction and civil engineering machinery, and the like, comes into contact with and slides on a seal member such as an oil seal, a dust seal, a mechanical seal, and the like. Note that, although these embodiments are explained as to an oil seal portion of a wind power generator as an example, the present invention can be also applied to a cylinder rod, a rotating shaft of a tracker roller, a swivel base drive unit used in large civil engineering and construction machinery such as large shovels, tractors, and the like, a lip type seal device of various rotating portions of large ships and the like, and a rotating shaft, a reciprocating shaft, a swinging shaft; and the like used in automobiles, general industrial machinery, and the like, and it is needless to say that the present invention encompasses the technical fields to which persons skilled in the art can easily apply the invention.

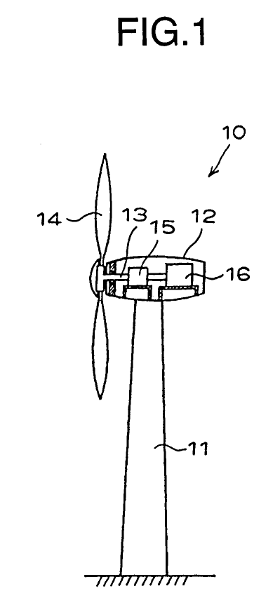

FIG. 1 shows the schematic structure of the wind power generator to which the sliding contact seal structure as a typical embodiment of the present invention is applied.

The wind power generator 10 is composed of a slender tower 11, a nacell 12 disposed at the upper end of the tower 11 so as to turn about a vertical axis, and a plurality of blades 14 disposed at an end of the nacell 12 and rotated by wind power about an approximately horizontal rotating shaft 13. The nacell 12 includes a speed increasing gear 15 for increasing the rotating speed of the rotating shaft 13 and an electric generator 16 coupled to the speed increasing gear 15.

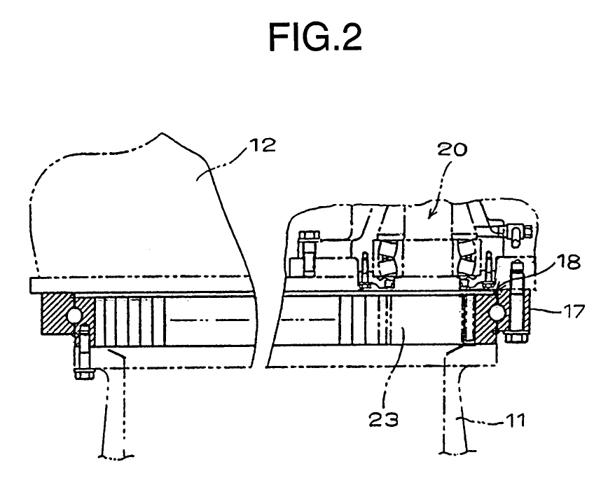

The nacell 12 automatically turns about the center line of the tower 11 in response to data obtained by and supplied from a not shown anemoscope disposed to the nacell 12. FIG. 2 schematically shows a turning mechanism of the nacell 12. In FIG. 2, reference numeral 17 denotes an outer turning race fixed on the lower surface of the nacell 12, and reference numeral 18 denotes an inner turning race fixed on the upper surface of the tower 11. The outer turning race 17 fixed on the lower surface of the nacell 12 is fitted on the inner turning race 18 fixed on the upper surface of the tower 11. The outer turning race 17 turns around the inner turning race 18 fixed on the tower 11. Further, internal teeth are cut on the inside diameter surface of the inner turning race 18.

The turning force of the nacell 12 is transmitted by a turning drive unit 20 fixed in the nacell 12 likewise.

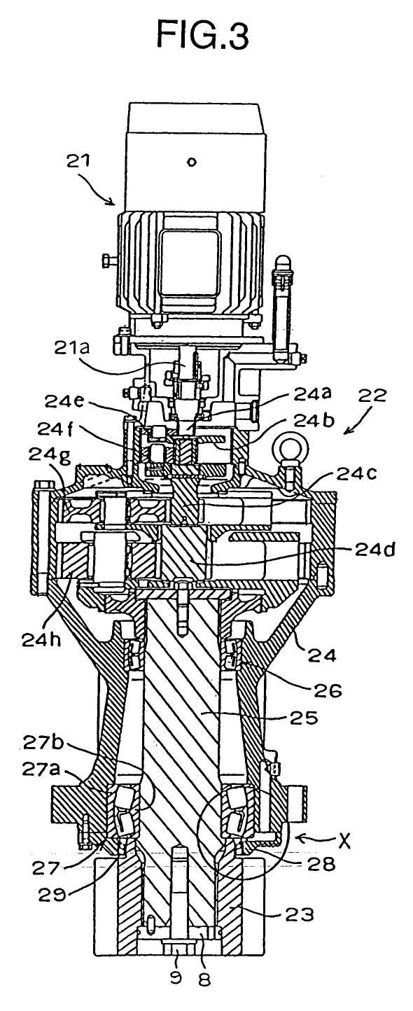

FIG. 3 shows an example of the structure of the turning drive unit 20 of the nacell 12. The turning drive unit 20 receives a data signal from the not shown anemoscope and transmits an output from a rotational speed of a motor 21, which is rotated and stopped through a not shown controller, to a pinion 23 after the rotational speed is greatly reduced through a reducer 22. The reducer 22 in the illustrated example is composed of four sun gears 24a to 24d, which are disposed along the axial line of an output shaft 21a of the motor 21, and a group of four large and small planetary gears 24e to 24h, these gears 24a to 24h being accommodated in a casing 24.

The pinion 23 is spline coupled with the lower end of a pinion shaft 25, which is rotated at a finally reduced rotating speed, so that the rotational direction of the pinion 23 is fixed, as well as the lower end surface of the pinion 23 is fixed in an axial direction by a bolt 9 through a fixing plate 8. The pinion 23 is meshed with the inside teeth of the inner turning race 18 fixed on the tower 11, and rotated at a reduced speed by the motor 21 through the reducer 22, thereby the pinion 23 rotates on the inside teeth of the inner turning race 18 by itself. The rotation of the pinion 23 prompts the outer turning race 17 fixed on the nacell 12 to rotate, which causes the nacell 12 to turn at a predetermined angle at a low speed on the upper end of the tower 11.

The pinion shaft 25 is rotatably journaled by first and second bearings 26 and 27 disposed at the upper and lower ends of the casing 24 of the reducer 22. A housing 28 is fixed on the lower end of the casing 24, and an oil seal 29, which constitutes a part of the sliding contact seal structure of the present invention, is interposed between the housing 28 and the pinion 23 to prevent the leakage of an oil from the second bearing 27. A lubricant supply path is formed on the lower end of the casing 24, and a lubricant is supplied from the lubricant supply path to the second bearing 27.

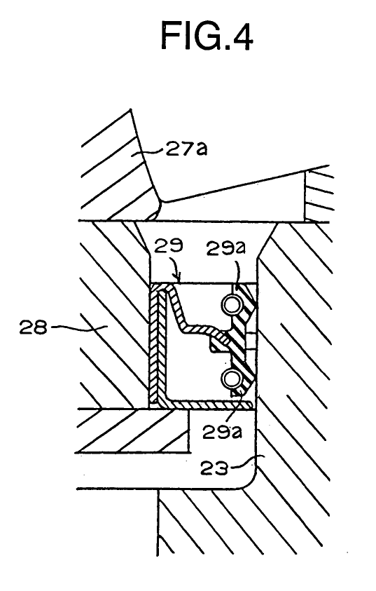

The sliding contact seal structure according to this embodiment is applied to a sliding contact seal structure between the oil seal 29 fitted and fixed to the housing 28 of the second bearing 27 and the pinion shaft 25. As shown in an enlarged fashion in FIG. 4, a double lip oil seal 29 having two lips 29a in a packing portion is used as the oil seal 29. It is needless to say that the oil seal 29 may be composed of an oil seal having a single lip.

In FIG. 4, a desired carbon steel (surface energy: 50 dyne/cm), which is subjected to no surface treatment and the material of which is regulated by JIS, is used as the pinion shaft 25, and four types of rubbers, i.e. an urethane rubber (surface energy: 48 dyne/cm), a vinyl chloride rubber (surface energy: 45 dyne/cm), a polyethylene rubber (surface energy: 38 dyne/cm), and a polytetrafluoroethylene (PTFE) rubber (surface energy: 22 dyne/cm) are used as the lips 29a of the oil seal 29 that act as the counter part of the pinion shaft 25.

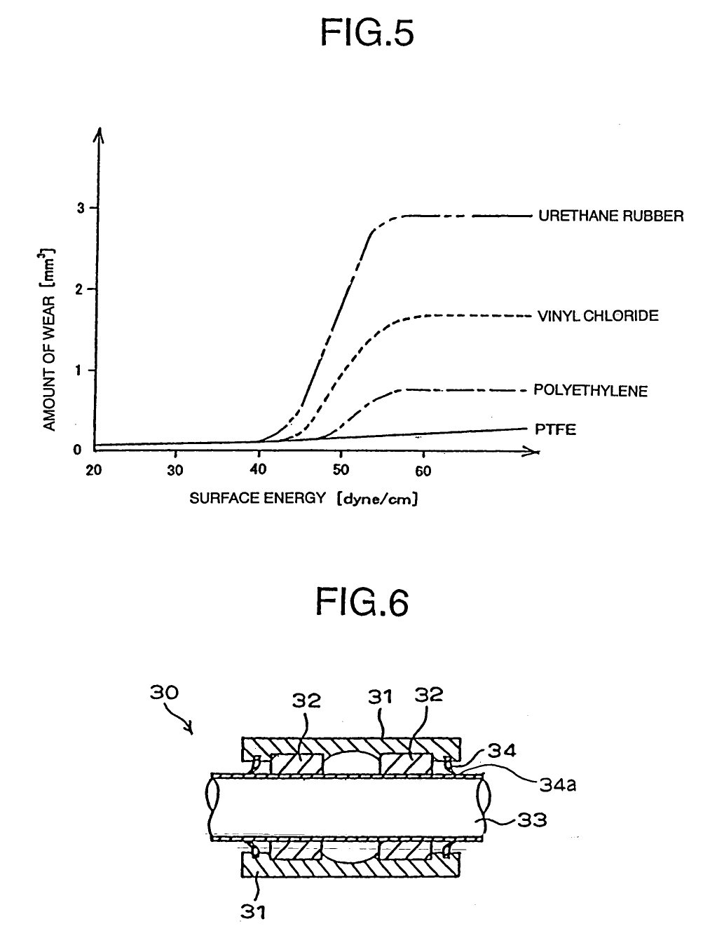

The wind power generator was operated for 500 hours by combining the above components. FIG. 5 shows a result of the operation at the time.

As can be understood from FIG. 5, the urethane rubber is worn in an amount of 1.8 mm³ or more, the vinyl chloride rubber is worn in an amount of 1.0 mm³ or more, the polyethylene rubber is worn in an amount of 0.3 mm³ or more, and the PTFE rubber is worn in an amount of 0.1 mm³ or more, that is, the amounts of wear of these rubbers decrease in the order of the magnitudes of their surface energy. When the timing at which the oil seal is replaced is taken into consideration, the urethane rubber and the vinyl chloride rubber cannot be practically used because they have a large amount of wear. In contract, it can be understood that the polyethylene rubber and PTFE rubber can extend the timing at which the oil seal is replaced because they have a very small amount of wear. That is, it can be found that if the polyethylene rubber or the PTFE rubber is used as the lips 29a of the oil seal 29 at the time the carbon steel whose surface is not subjected to a surface treatment is used as the pinion shaft 25, the polyethylene or PTFE rubber can be sufficiently practically used and its durability can be increased.

FIG. 6 shows an example of a sliding contact seal structure as another embodiment of the present invention. In FIG. 6, a working link portion 30, which acts as the sliding contact seal structure, includes a cylindrical housing 31 and a shaft member 33. The shaft member 33 is rotatably and swingably press fitted into bushes 32,32 which are hermetically fitted on the cylindrical housing 31, and both the ends of the shaft member 33 are exposed to the outside. The portion between the shaft member 33 and the cylindrical housing 31 is sealed by lip seal members 34,34 which composed of a nitrile rubber and coaxially fitted to the openings of the cylindrical housing 31 at both the ends thereof. A not shown lubricant is introduced between the shaft member 33 and the bushes 32. The lip portions 34a of the seal members 34 come into intimate contact with the surface of the shaft member 33 and prevent the internal wear between the shaft member 33 and the bushes 32 and the seal members 34 by preventing the invasion of foreign particles such as dusts, earth and sand muddy water, and the like from the outside into the link portion 30 as well as preventing the leakage of the lubricant to the outside of the link portion 30.

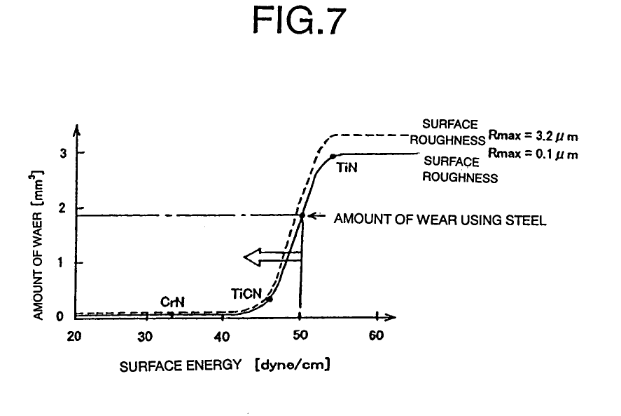

In this embodiment, used materials as the shaft member 33 were four kinds of materials, i.e. a carbon steel (surface energy: 50 dyne/cm) whose surface is not subjected to a surface treatment, a carbon steel (surface energy: 53 dyne/cm) whose surface is subjected to a TiN film forming treatment, a carbon steel (surface energy: 45 dyne/cm) whose surface is subjected to a TiCN film forming treatment, a carbon steel (surface energy: 34 dyne/cm) whose surface is subjected to a CrN film forming treatment, and an urethane rubber is used as the seal members 34. In the above circumstances, the link portion 30 was continuously rotated and swung for 150 hours, and FIG. 7 shows the amount of wear of the urethane rubber at that time.

Note that chemical deposition such as plasma CVD, and PVD (physical vapor deposition) such as vacuum deposition, sputtering, and the like can be applied to the film forming treatment described above. The film was formed in a thickness of 1 μm. In the film forming treatment of this embodiment, each of the shaft members 33, which were composed of the carbon steels, was dipped into a predetermined alkaline solution and cleaned so that an oxide film deposited on the shaft member 33 was absorbed and removed, and then an alkaline component deposited on the shaft member 33 was washed with water and removed. Subsequently, the shaft member 33 was dried with hot air having a desired temperature. After the shaft member 33 was dried, it was cleaned in a fluorine vapor stream so that the dirt thereof such as oil, water and the like deposited thereon could be sufficiently removed.

Next, after the cleaned shaft member 33 was moved into and placed in a vacuum chamber, the atmosphere in the vacuum chamber was evacuated to about 0.1 Pa by a not shown vacuum pump, and a N₂ gas was introduced into the chamber to 10 m Torr. Then, a bias voltage of about 1 KV was applied to the surface of the shaft member 33 from a sputtering source disposed in the vacuum chamber and collided against the surface of the shaft member 33 in rotation while maintaining the above atmosphere so as to form a film having a desired thickness. Ti and Cr described above were used as the material of the sputtering source. Next, the working link portion 30 was assembled by mounting the shaft member 33 in the housing 31 of the link portion 30 so that the lip seal members 34 composed of the polyurethane rubber come into intimate contact with the housing 31 and the shaft member 33.

After the thus assemble working link portions 30 were continuously rotated with respect to the shaft members 33 for 150 hours, the link portions 30 were broken down and the amounts of wear of the seal members corresponding to the respective shaft members 33 were measured. FIG. 7 shows the result of measurement. It is found from the graph that the amount of wear of the urethane rubber (surface energy: 48 dyne/cm), which is used as the seal members in the shaft member 33 whose surface is subjected to the TiN (surface energy: 53 dyne/cm) film forming treatment, is 3.0 mm³, and the amount of wear of the urethane rubber used in the shaft member 33 composed of carbon steel whose surface is not subjected to the surface treatment (surface energy: 50 dyne/cm) is 1.8 mm³, and thus the amounts of wear of both the urethane rubbers in these cases are very large, whereas the amount of wear of the urethane rubber, which is used in the shaft member 33 whose surface is subjected to the TiCN (surface energy: 45 dyne/cm) film forming treatment, is 0.3 mm³, and the amount of wear of the urethane rubber, which is used in the shaft member 33 whose surface is subjected to a CrN (surface energy: 34 dyne/cm) film forming treatment, is 0.1 mm³, and thus the amounts of wear of both the urethane rubbers in these cases are very small.

From what has been described above, since the amount of wear of the lip seal members 34 is increased depending on a combination of the materials used as the lips 29a of the oil seal 29 and the seal members 34 and the materials used as the pinion shaft 25 and the shaft member 33, it can be understood that there is a case in which it is difficult to use the combination as the sliding contact seal structure from the view point of durability. It can be also understood that the durability of the sliding contact seal structure can be improved depending on a combination of materials, in addition to the above case. When the shaft member, which is composed of the steel carbon whose surface is not subjected to the surface treatment, is used as described above, it is not preferable to use the urethane rubber as the seal members. However, when the polyethylene rubber, for example, is used to the shaft member composed of the steel carbon whose surface is not subjected to the surface treatment, the durability of the sliding contact seal structure can be improved. When this is examined from a view point of surface energy, required durability can be secured by combining the shaft member with the seal members such that the sum of the surface energies thereof is 95 dyne/cm or less.

What is claimed is:

1. A sliding contact seal structure used in various machines having a shaft member that comes into contact with a seal member and relatively slides with respect to the seal member, wherein a surface energy of the shaft member is 50 dyne/cm or less on a sliding contact surface of the shaft member.

2. A sliding contact seal structure according to claim 1, comprising a combination of the seal member and the shaft member, and a sum of a surface energy of the seal member and the surface energy of the shaft member being 95 dyne/cm or less on a sliding contact surface of the seal member and the sliding contact surface of the shaft member.
